(19) United States
(12) Patent Application Publication
(10) Pub. No.: US 2015/0223507 A1
(43) Pub. Date: Aug. 13, 2015

(54) FOOD PRODUCT

(71) Applicant: Cargill, Incoporated, Wayzata, MN (US)

(72) Inventors: Nathan Allen Baldauf, Wichita, KS (US); Roxana Yglesias Carrillo, Wichita, KS (US); Brock Aaron Zentz, Andover, KS (US)

(73) Assignee: Cargill, Incoporated, Wayzata, MN (US)

(21) Appl. No.: 14/409,768

(22) PCT Filed: Jun. 19, 2013
(86) PCT No.: PCT/US2013/046511

§ 371 Date: Dec. 19, 2014

Related U.S. Application Data
(60) Provisional application No. 61/661,427, filed on Jun. 19, 2012.

(51) Int. Cl. A23L 1/31; A23L 1/315

(52) U.S. Cl. CPC A23L 1/31; A23L 1/315; A23V 2002/00

(57) ABSTRACT

Systems and methods for producing food products are disclosed. In one embodiment, a food product includes a first protein comprising uncooked meat in an amount of about 30 wt. % to about 95 wt. %. The food product also includes a second protein comprising preserved meat in an amount of about 9 wt. % to about 50 wt. %. The food product also includes a non-meat composition in an amount of about 0 wt. % to about 35 wt. %.

### TECHNICAL FIELD

The present disclosure relates generally to food products and methods. Aspects of the disclosure are particularly directed to food products comprising multiple proteins, and more specifically an uncooked protein and a cooked protein filler.

### BACKGROUND

It is known to form food products, such as strips of meat. Examples of such formed food products are shown and described in U.S. patent application Ser. No. 12/454,597 published as US 2009/0297674 A1 titled “Formed Meat Strip Products And Methods Of Making Such Products” filed May 20, 2009 by Brock Zentz and assigned to Cargill, Incorporated. However, such formed food products do not include a primary protein (such as ground beef) having a non-meat filler (such as cheese).

It is also known to co-extrude food products, where one of the extrudates is a protein such as meat, and the other extrudate is a filler such as cheese. Examples of such co-extruded food products are shown and described in U.S. patent application Ser. No. 13/123,449 published as US 2011/0195159 A1 titled “Methods And Systems For Making Co-Extruded Food Products” filed Oct. 8, 2009 by Jay David Parker et al. and assigned to Cargill, Incorporated. However, such co-extruded food products do not include a primary protein (such as ground beef) having a cooked filler (such as bacon) and an uncooked filler (such as cheese).

Accordingly, it would be advantageous to provide a food product comprising a primary protein (such as ground beef) having a cooked filler (such as bacon) and an uncooked filler (such as cheese) and a method for making the same.

### BRIEF DESCRIPTION OF THE DRAWINGS

FIG. 1 is a top plan view of a food product according to an exemplary embodiment of the present disclosure.

FIG. 2A is cross-sectional view of the food product of FIG. 1 along line 2A-2A.

FIG. 2B is cross-sectional view of the food product of FIG. 2A according to an alternative embodiment of the present disclosure.

FIG. 2C is cross-sectional view of the food product of FIG. 2A according to an alternative embodiment of the present disclosure.

FIG. 3 shows a graph of desirability of a bacon and cheddar beef patty at different levels of cheese.

FIG. 4 shows a graph of desirability of a bacon and cheddar beef patty at different levels of fully cooked bacon.

FIG. 5 shows a graph of desirability of a bacon and cheddar chicken patty at different levels of cheese.

FIG. 6 shows a graph of desirability of a bacon and cheddar chicken patty at different levels of fully cooked bacon.

### DETAILED DESCRIPTION

Specific details of several embodiments of the disclosure are described below with reference to a food product. One aspect of the present disclosure is directed a food product including a first protein comprising uncooked protein in an amount of about 30 weight percentage (wt. %) to about 95 wt. %. The food product also includes a second protein comprising preserved meat in an amount of about 9 wt. % to about 50 wt. %. The food product also includes a non-meat composition in an amount of about 0 wt % to about 35 wt. %. In some embodiments, the food product may be a patty. In some embodiments, the food product may be a chub.

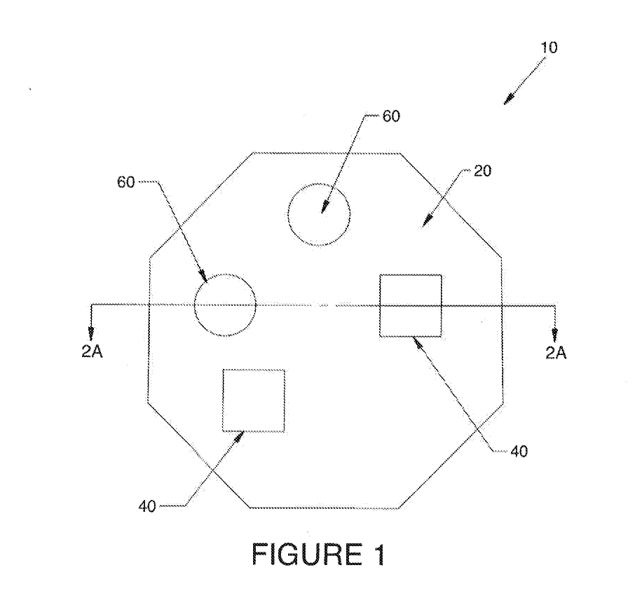

A food product is shown in FIG. 1 as a patty 10 according to an exemplary embodiment of the present disclosure. The food product includes a web or base layer structure shown as a primary protein or meat block 20. As used herein, the terms “meat” and “meat block” refer to the flesh obtained from any animal protein source such as, for example, bovine, porcine, equine, caprine, ovine, avian animals, seafood animals, or any animal commonly harvested for food production. Meat block 20 includes a primary filler such as an additive or particle, and shown as a secondary protein or meat tiller 40. Meat block 20 may also optionally include a secondary filler such as an additive or particle layer and shown as a non-meat filler 60.

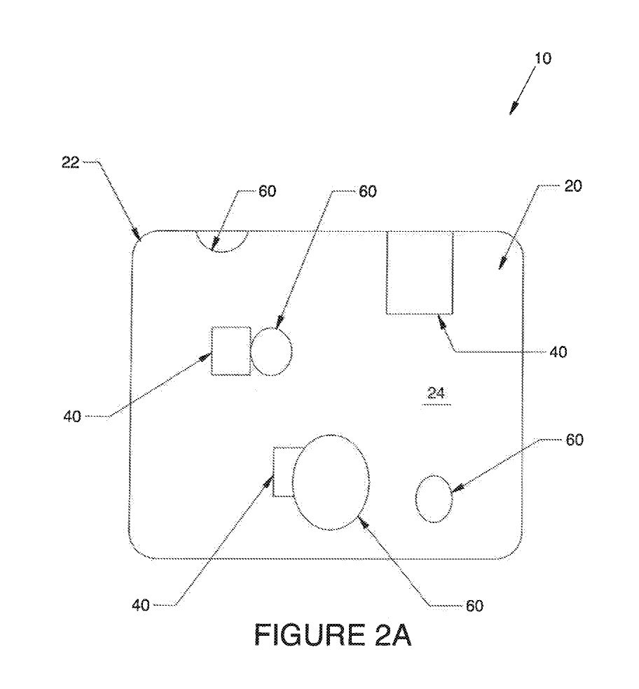

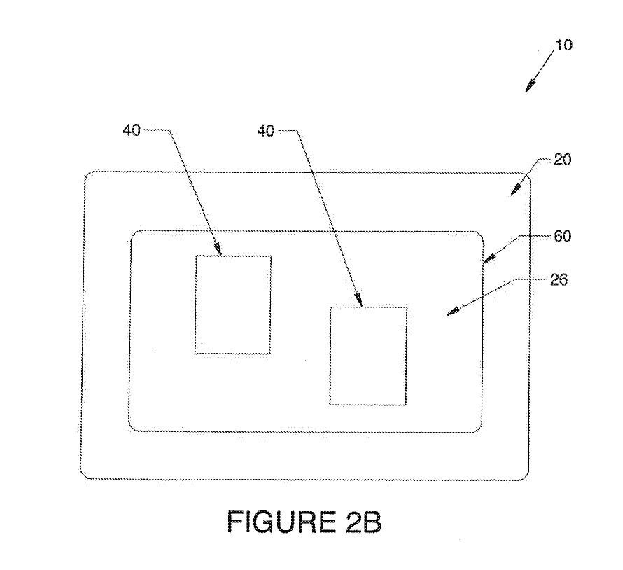

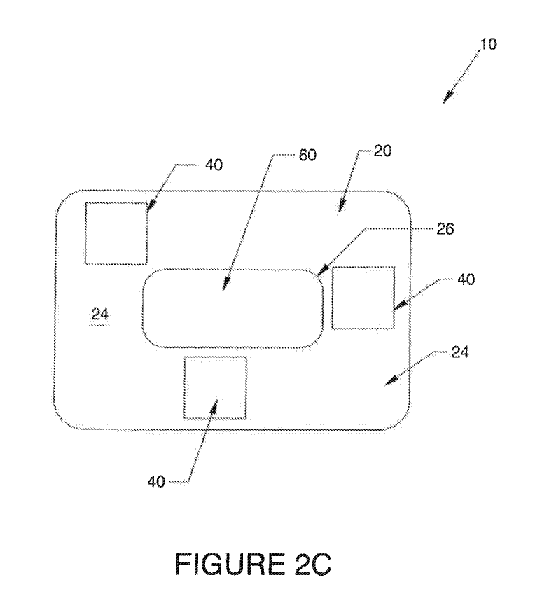

As shown in FIG. 2A, some particles of meat filler 40 and non-meat filler 60 are visible on an outer surface 22 of meat block 20. As shown in FIG. 2A, other particles of meat filler 40 and non-meat filler 60 are blended throughout meat block 20 and are located in an interior 24 of meat block 20. Some particles of meat filler 40 and non-meat filler 60 may be located adjacent to, connected to, or intertwined with each other as shown in FIG. 2A according to alternative embodiments.

Meat block 20 may be a layer that is layered relative to a layer of non-meat filler 60 as shown in FIG. 2B. In FIG. 2B and in FIG. 2C, non-meat filler 60 is shown layered in an interior cavity 26 of meat block 20, such that the layer of meat block 20 substantially surrounds or encapsulates the layer of non-meat filler 60. According to an alternative embodiment, the meat filler may be layered in the interior cavity of the meat block. Accordingly, the meat block may be referred to as being “stuffed” or layered with the meat filler and/or the non-meat filler. As shown in FIG. 2B according to one embodiment, meat filler 40 may also be situated within interior cavity 26, As shown in FIG. 2C according to another embodiment, meat filler 40 may be situated outside interior cavity 26.

Referring back to FIG. 1, in some embodiments, patty 10 is a ground beef, ground chicken, ground turkey, or ground pork patty. According to a preferred embodiment, the patty is substantially shaped as a circle. The patty may have an uncooked diameter of about 6 inches, about 5 inches, or about 4 inches. The patty may have an uncooked thickness of about 1 inch, about 0.8 inch, about 0.6 inch, or about 0.4 inch. In some embodiments the uncooked weight of the patty may be less than about 10 ounces, less than about 8 ounces, less than about 6 ounces, less than about 5 ounces, less than about 4 ounces, less than about 3 ounces, less than about 2 ounces, or less than about 1 ounce. The patty can weigh about 5.3 ounces (uncooked weight) according to a preferred embodiment. In some embodiments, the meat filler is shaped as an irregular particle, and may be diced, cubed, shredded, formed, pressed, etc according to alternative embodiments. The meat filler can have an average length after cooking of about 3 inches, about 2 inches, about 1 inch, or about 0.5 inch. The meat filler has an average length of about 1 inch (cooked) according to a preferred embodiment. In some embodiments, the non-meat filler is shaped as a regular particle, and may be diced, cubed, shredded, formed, pressed, etc. according to alternative embodiments. The meat filler may have an average cooked diameter of about ⅝ inch, ½ inch, ⅜ inch, 2/8 inch, or ⅛ inch. The meat filler has an average diameter of about ⅜ inch (cooked) according to a preferred embodiment.

In some embodiments, patty 10 may be a portion of the food product in the form of a chub. The chub may have an uncooked diameter of at least about 6 inches, at least about 5 inches, at least about 4 inches, or at least about 3 inches. The chub may have an uncooked length of at least about 48 inches, at least about 24 inches, at least about 12 inches, or at least about 6 inches. In some embodiments the uncooked weight of the chub may be at least about 20 pounds, at least about 10 pounds, at least about 5 pounds, at least about 3 pounds, at least about 2 pounds, or at least about 1 pound.

In some embodiments, the weight percentage (wt. %) of the meat block is in an amount of about 30 wt. % to about 95 wt. %, about 40 wt. % to about 80 wt. %, or about 50 wt. % to about 70 wt. % relative to the total wt. % of the food product. In some embodiments, the weight percentage of the meat filler is in an amount of about 9 wt. % to about 50 wt. %, about 10 wt % to about 40 wt. %, about 11 wt. % to about 30 wt. %, or about 12 wt. % to about 25 wt. % relative to the total wt. % of the food product. According to a particularly preferred embodiment, the meat filler is in an amount of about 9 wt. % to about 27 wt. %. In some embodiments, the wt. % of the non-meat filler is in an amount of about 0 wt. % to about 35 wt. %, about 5 wt % to about 30 wt. %, of about 10 wt. % to about 25 wt. % relative to the food product. According to a particularly preferred embodiment, the non-meat tiller is in an amount of about 15 wt. % to about 30 wt. %. The ratios of wt. % of the meat block to the meat filler and the non-meat filler may vary according to the particular ingredients according to other alternative embodiments.

In some embodiments, the meat filler is between about 10 wt. % to about 27 wt. %, and the non-meat filler is a cheese at about 0 wt. % to about 35 wt. %, and may vary according to the specific meat of the meat block (e.g. beef and pork). In poultry, the preferred range of the meat filler is about 9 wt % to about 27 wt %, and the preferred range of the non-meat filler (i.e., cheese) is about 15 wt. % to about 30 wt. %.

The meat block may be obtained from any animal protein source such as bovine, porcine, equine, caprine, ovine, avian animals, seafood animals, or any animal commonly harvested for food production. Bovine animals include, but are not limited to buffalo, bison, and all cattle, including steers, heifers, cows, and bulls. Porcine animals include, but are not limited to feeder pigs and breeding pigs, including sows, gilts, bar-rows, and boars. Ovine animals include, but are not limited to, sheep, including ewes, rams, wethers, and lambs. Caprine animals include, but are not limited to, goats, including does, bucks, wethers, and kids. Avian animals include, but are not limited to, birds, including chickens, turkeys, and ostriches (and also include domesticated birds also referred to as poultry). Seafood animals (including from salt water and freshwater sources) include, but are not limited to, fish and shellfish (such as clams, scallops, shrimp, crabs and lobster). Accordingly to a particularly preferred embodiment, the meat block is ground beef with a final grind size of about ⅛ inch.

The meat filler is preferably a preserved meat. Meat preservation methods include, for example, cooking, curing, smoking, dehydrating, and pickling. Cooked meats can include, for example, seasoned or non seasoned cooked beef, pork, lamb, and bison. The cooked meats may be further processed such as by corning, shredding, broiling, flame broiling, grilling, roasting, searing, rotisserie cooking, etc. The cooked meats may be even further processed into a final product such as bacon, hot dog, sausage, cold cuts, etc. Cured meats can include, for example, bacon, ham, prosciutto, salami, pepperoni, etc. According to a preferred embodiment, the meat filler is bacon (e.g., the fatty slab taken from the underside of a pig also referred to as pork belly or side pork). According to alternative embodiments, the meat filler may be a bacon substitute such as turkey bacon, smoked ham, Canadian bacon, pancetta, salt pork, etc. According to an alternative embodiment, the meat filler may be imitation bacon bits (e.g. soy protein).

The non-meat filler is preferably a dairy or milk-based product, and may be a vegetable (e.g., carrots, peas, onions, herbs, etc.), fruit product (e.g., berry, apple, etc.), or other food additive such as a sauce, flavor, or spice according to alternative embodiments. According to a preferred embodiment, the non-meat filler is a cheese such as, for example, fresh cheese (e.g., cream cheese, ricotta cheese, cottage cheese, etc.), soft cheese (e.g., brie, camembert, feta, etc.), semi-soft cheese (e.g., mozzarella, Monterrey jack, muenster, provolone, etc.), semi-firm cheese (e.g., cheddar, Colby, Swiss, etc.), firm cheese (e.g., dry jack, parmesan, Romano, etc.), blue cheese, processed cheese (e.g., American, cheese food, cheese spread), etc. In applications where the food product is produced a co-extrusion product (see e.g., U.S. patent application Ser. No. 13/123,449 published as US 2011/0195159 A1 titled “Methods And Systems For Making Co-Extruded Food Products” filed Oct. 8, 2009 by Jay David Parker et al. and assigned to Cargill, Incorporated, which is hereby incorporated by reference in its entirety) the cheese preferably has a viscosity and a high melting point such that when cooking the food product on the grill or stove, etc., the cheese layer does not melt, flow or ooze out of the food product. According to a preferred embodiment, the cheese does not flow at a temperature of about 180° F.

The food product may be made according to conventional industrial hamburger forming methods. According to one such method, the meat filler and the non-meat filler may be mixed or blended with the meat block and pumped into a mold cavity of a mold plate (or pumped and crimped or cut) at certain intervals in order to form patties (e.g., using a Formax 8000 forming equipment commercially available from Formax Inc. of Mokena, Ill.). According to another such method, the meat block and the filling may be co-extruded, e.g., meat filler such as a slurry of bacon, being pumped in pulses through a tube that is surrounded by a continuous, vertical flow of meat. The meat block is then crimped to enclose the bacon within the meat. Such patties may be formed at a commercial or industrial speed of about 60-100 patties per minute (e.g., using Coex 893 co-extrusion equipment (VEMAG Maschinenbau GmbH, Verden, Germany)).

According to a preferred embodiment, each of the finished food products made at commercial speed using automated equipment is substantially uniform in size and/or shape. By “substantially uniform in size” is meant that a test sample group of food products has an average size variation from one piece to another of less than 10% by weight, and preferably less than 5% by weight. By “substantially uniform in shape” is meant that a test sample group of food products has a shape variation in height, width and length from one piece to another of less than 10% in anyone dimension.

In some embodiments, the meat block is uncooked (e.g., raw) and the meat filler is cooked (e.g., fully cooked). After formation of the food product, the meat block may stay in the fresh (e.g., refrigerated) state, or it may be frozen according to alternative embodiments. In the frozen state, the meat block may be at a temperature of about −10° F. to about 20° F., more preferably about 0° F. to about 10° F. In some embodiments, after formation of the food product, the food product may be heated such that the uncooked meat block is cooked (e.g., fully cooked) to provide a cooked food product. The cooked food product may stay in the fresh (e.g., refrigerated) state, or it may be frozen according to alternative embodiments. In the frozen state, the cooked food product may be at a temperature of about −10° F., to about 20° F., more preferably about 0° F. to about 10° F.

### EXAMPLES

Aspects of certain methods in accordance with aspects of the disclosure are illustrated in the following Examples.

### Example 1

A platform of “stuffed” patties (e.g., a food product) that blend raw meat (e.g., a meat block) with cooked meat (e.g., a primary or meat filler) and cheese (e.g., a secondary or non-meat filler) based on a response surface design of experiments was formulated. By utilizing a Response Surface Design of experiment considering Nine Point Hedonic Testing for overall acceptability, cooked meat liking, cheese liking and along with Just About Right testing (“JAR”) for cooked meat and cheese, panelists evaluated different formulation ranges. Based on a minimum score of 5.5 which is at least a slight liking for hedonic and 65% of panelists thinking the product is “just about right”, desirability ranges were constructed.

A formula range that will produce a desirable platform of “stuffed” burgers which blend a cooked meat (e.g., meat filler) and/or cheese (e.g., non-meat filler) and a raw protein base (e.g., meat block).

### Methodology:

### Phase I

A rotatable inscribed central composite design with α=1.4 was employed to formulate beef and chicken patties using a mixture of fully cooked bacon and cheese. The design consisted of four full factorial points (F1 to F4), four axial points (A1 to A4) and four center points (C1 to C4). Twelve treatments were formulated and formed into patties and frozen. From frozen, patties were cooked to 160 F and served to 120 panelists. A Randomized Incomplete Block Design was utilized to serve a maximum of 4 treatments per panelist to avoid sensory fatigue. Samples were presented simultaneously and judges were instructed to cleanse their palate with unsalted crackers and water before and in between samples, independent variables analyzed consisted of cheese (X1) and bacon (X2) percentage ranges. The dependent variables investigated were Just About Right Scales for Cheesiness (Y1) (Not Cheesy Enough to Too Cheesy), Baconiness (Y2) (Not Enough Bacon to Too Much Bacon) and 1-9 Structured Hedonic Scales to evaluate Cheese Impact (Y3), Bacon Impact (Y4) and Overall Acceptability (Y5). Mathematical models containing only the significant terms were generated for each response parameter using multiple linear regression analysis and analysis of variance. A desirability function was calculated to simultaneously optimize JAR and Hedonic scores. Different weights and optimization settings were defined for each response as follows: percentage of JAR for cheesiness and baconiness (maximized for minimum of 65% and a weight of 5); hedonic scores for cheese and bacon (maximized for a minimum of 5.5 and weight of 3) and overall product acceptability (maximized for a minimum of 5.5 and a weight of 1).

### Ballot Design

Just About Right (“JAR”) Scales: Cheesiness (“Not Cheesy Enough” to “Too Cheesy”); Baconiness (“Not Enough Bacon” to “Too Much Bacon”); Tenderness (“Too Tender” to “Too Tough”); and Flavor (“Not Strong Enough” to “Too Strong”).

1-9 Structured Hedonic Scales were used to evaluate Cheese Impact, Bacon Impact, and Overall Product Acceptability (1=dislike extremely, 2=dislike very much, 3=dislike moderately, 4=dislike slightly, 5=neither like nor dislike, 6=like slightly, 7=like moderately, 8=like very much, 9=like extremely).

### Statistical Analysis

Response means were calculated for each treatment and analyzed using JMP Statistical Software, v. 9, 2010 (SAS Institute Inc., Cary, N.C., USA) under the Response Surface Model platform. A desirability function was calculated to simultaneously optimize JAR and Hedonic scores. Different weights and optimization settings were defined for each response as follows: percentage of JAR for Cheesiness and Baconiness (maximized for minimum of 65% and a weight of 5); hedonic scores for cheese and bacon (maximized for a minimum of 5.5 and weight of 3) and Overall Product Acceptability (maximized for a minimum of 5.5 and a weight of 1).

### Phase II

### Methodology

Panelists were presented with samples corresponding to products with different formulations in the specified ranges based on desirability for either poultry or red meat. Combinations included cooked bacon and cheddar cheese in raw beef, cooked bacon and cheddar cheese in raw chicken, cooked pepperoni with mozzarella cheese in raw chicken, cooked pepperoni with mozzarella in raw pork, cooked ham with Swiss cheese in raw turkey and a blend of cooked meats including salami, pepperoni and ham with provolone cheese in raw beef. They were instructed to cleanse their palate with unsalted crackers and water before and in between samples.

From frozen, patties were cooked to 160° F. and served to at least 64 panelists. Samples were presented one at a time and judges were instructed to cleanse their palate with unsalted crackers and water before and in between samples.

### Ballot Design

1-9 Structured Hedonic Scales were used to evaluate Overall Flavor and Overall Acceptability (1=dislike extremely, 2=dislike very much, 3=dislike moderately, 4=dislike slightly, 5=neither like nor dislike, 6=like slightly, 7=like moderately, 8=like very much, 9=like extremely).

### Statistical Analysis

Data from liking scores was analyzed by ANOVA.

### Results—Phase I

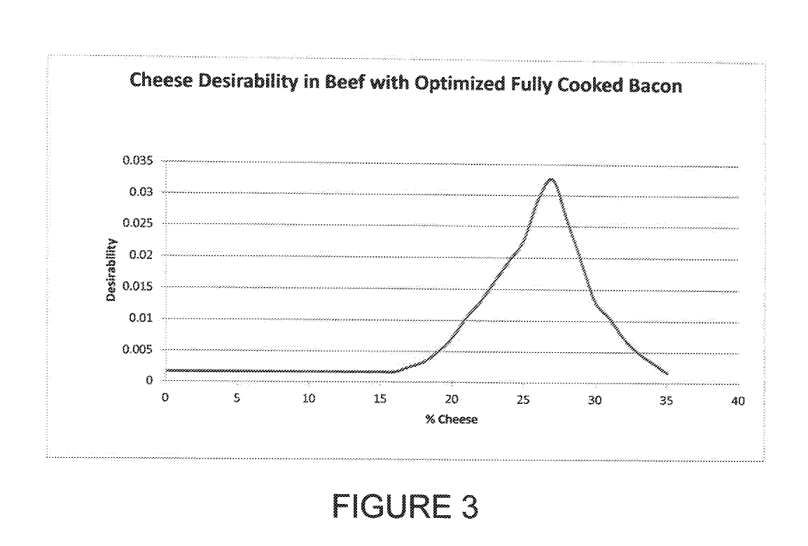

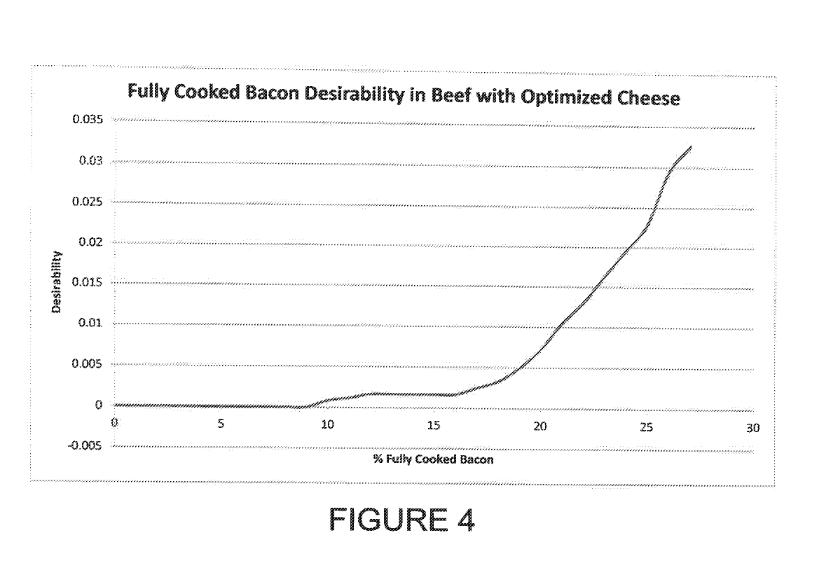

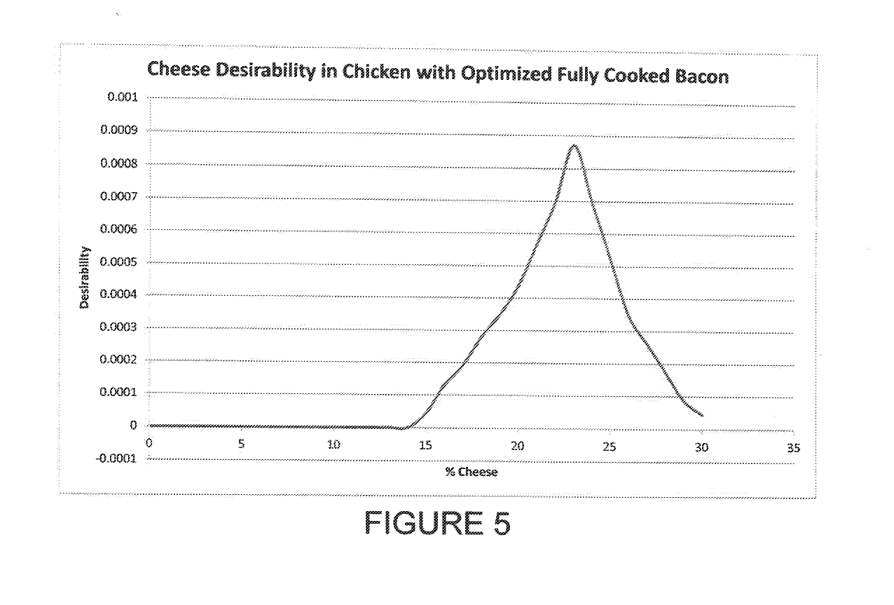

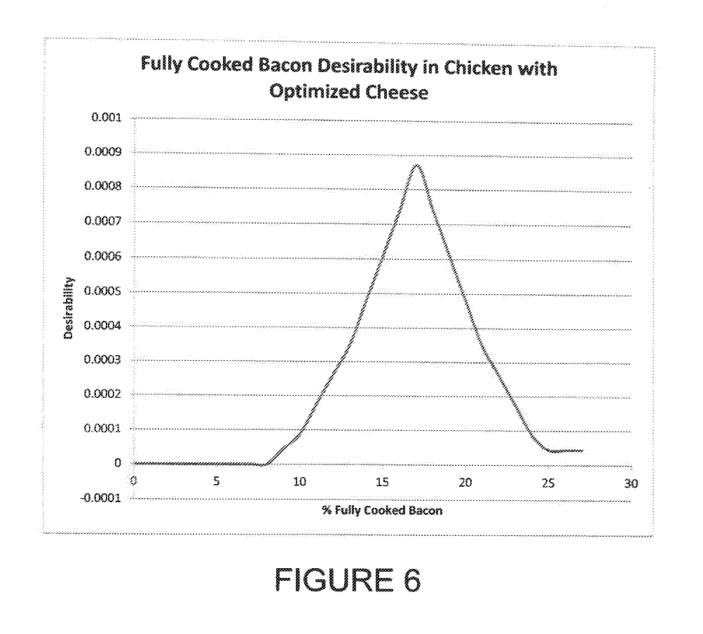

Based on a minimum hedonic score of 5.5 for bacon impact, cheese impact and Overall Acceptability, which is at least a slight liking and 65% of panelists thinking the product is “just about right” for Cheesiness and Baconiness, desirability ranges were created. The results of Phase I are shown in FIG. 3 through FIG. 6. The data in FIG. 3 through FIG. 6 indicate that based on consumer data for desirability, for beef patties, cheese was preferred to be at 0-35 wt. % (FIG. 3), and bacon was preferred to be between 10 wt % and 27 wt. % (FIG. 4). In poultry patties, cheese was preferred to be at 15 wt. % to 30 wt. % (FIG. 5), and bacon was preferred to be at 9 wt. % to 27 wt. % (FIG. 6).

### Results—Phase II

The results of Phase 11 are shown below in Table 1.

TABLE 1

| Cooked | Cheese | Raw | Overall |
|---|---|---|---|
| Meat | Type | Meat | Acceptability |
| Bacon | Cheddar | Beef | 7.08 |
| Pepperoni, Salami, Ham | Provolone | Beef | 6.80 |
| Bacon | Cheddar | Chicken | 6.76 |
| Pepperoni | Mozzarella | Chicken | 6.74 |
| Ham | Swiss | Turkey | 6.84 |
| Pepperoni | Mozzarella | Pork | 7.33 |

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. When the claims use the word “or” in reference to a list of two or more items, that word covers all of the following interpretations of the word: any of the items in the list, all of the items in the list, and any combination of the items in the list.

The above detailed descriptions of embodiments of the disclosure are not intended to be exhaustive or to limit the invention to the precise form disclosed above. Although specific embodiments of, and examples for, the invention are described above for illustrative purposes, various equivalent modifications are possible within the scope of the invention, as those skilled in the relevant art will recognize. For example, while steps are presented in a given order, alternative embodiments may perform steps in a different order. The various embodiments described herein can also he combined to provide further embodiments.

In general, the terms used in the following claims should not be construed to limit the invention to the specific embodiments disclosed in the specification, unless the above detailed description explicitly defines such terms. While certain aspects of the invention are presented below in certain claim forms, the inventors contemplate the various aspects of the invention in any number of claim forms. Accordingly, the inventors reserve the right to add additional claims after filing the application to pursue such additional claim forms for other aspects of the invention.

I/We claim:

1. A food product, comprising:
a first protein comprising uncooked meat in an amount of about 30 wt. % to about 95 wt. %;
a second protein comprising preserved meat in an amount of about 9 wt. % to about 50 wt. %; and
a non-meat composition in an amount of about 0 wt. % to about 35 wt. %.

2. The food product of claim 1, wherein the second protein comprises about 9 wt. % to about 40 wt. %.

3. The food product of claim 1, wherein the second protein comprises about 9 wt. % to about 35 wt. %.

4. The food product of claim 1, wherein the second protein comprises about 9 wt. % to about 30 wt. % and the non-meat composition comprises about 15 wt. % to about 30 wt %.

5. The food product of claim 1, wherein the second protein comprises bacon comprising about 9 wt. % to about 27 wt. % and wherein the non-meat composition comprises cheese comprising about 15 wt. % to about 30 wt. %.

6. The food product of claim 4, wherein the first protein comprises meat comprising at least one of beef, pork, lamb, bison, chicken, turkey, ostrich, or a combination thereof.

7. The food product of claim 4, wherein the first protein comprises chicken.

8. The food product of claim 4, wherein the first protein comprises ground beef.

9. The food product of claim 4, wherein the first protein is raw and in the fresh or frozen state.

10. The food product of claim 4, wherein the first protein is at a temperature of about −10° F. to about 20° F.

11. The food product of claim 4, wherein the first protein is at a temperature of about 0° F. to about 10° F.

12. The mod product of claim 8, wherein the preserved meat is preserved by at least one of a cooking, curing, smoking, dehydrating, or pickling process.

13. The food product of claim 12, wherein the second protein comprises at least one of cooked meats (seasoned or non seasoned cooked beef, pork, lamb, bison including but not limited to the aforementioned being corned, bacon, shredded, hot dog, salami, pepperoni, jerky, roasted, rotisserie, flame broiled), cooked poultry (seasoned or non seasoned cooked chicken, turkey, ostrich including but not limited to the aforementioned being corned, bacon, shredded, hot dog, salami, pepperoni, jerky, roasted, rotisserie, flame broiled) or combination of cooked meats and/or cooked poultry (seasoned or non seasoned cooked meat and/or poultry being corned, bacon, shredded, hot dog, salami, pepperoni, jerky, roasted, rotisserie, flame broiled).

14. The food product of claim 12, wherein the second protein is fully cooked.

15. The food product of claim 12, wherein the second protein comprises bacon.

16. The food product of claim 12, wherein the non-meat composition comprises at least one of cheese, fruit, vegetable, or sauce.

17. The food product of claim 12 wherein the non-meat composition comprises cheese comprising at least one of American cheese, cheddar cheese, blue cheese, pepper jack cheese, mozzarella cheese, provolone cheese, Swiss cheese, flavored cheese, aforementioned cheese products, or a combination thereof.

18. The food product of claim 12, wherein the non-meat composition comprises cheddar cheese.
